(19) United States
(12) Patent Application Publication
(10) Pub. No.: US 2007/0283923 A1
(43) Pub. Date: Dec. 13, 2007

(54) ADJUSTING DEVICE FOR THE ADJUSTING OF AT LEAST ONE VALVE IN AN INTERNAL COMBUSTION ENGINE

(75) Inventors: Rachid Khelifati, Berlin (DE); Isao Fukumoto, Berlin (DE)

Correspondence Address: GRIFFIN & SZIPL, PC, SUITE PH-1, 2300 NINTH STREET, SOUTH, ARLINGTON, VA, 22204, US

(73) Assignee: PIERBURG GMBH, Neuss (DE)

(21) Appl. No.: 11/759,715

(22) Filed: Jun. 7, 2007

(30) Foreign Application Priority Data
Jun. 7, 2006 (DE) 10 2006 026 446.0

(51) Int. Cl. F02B 31/00; F02D 11/10

(52) U.S. Cl. 123/306; 123/399

(57) ABSTRACT

Known adjusting devices, in a drive motor and subsequent gearing which is arranged in a housing and closed by a lid, have conductors to produce contact of a motor, a plug, or an electronic control system, which conductors are welded to the corresponding mating contacts or are embodied as corresponding plug contacts. According to the invention conductors are employed as a stamped grid and sheathed with the plastic of a lid. Moreover the opposite ends of the conductors are likewise sheathed by a plastic of the housing. Non-sheathed sections of the conductors arranged between the two housing parts serve according to the invention as a hinge to produce the defined opening and closing of the lid relative to the housing. Moreover, the entire electronic control system with an angle sensor and power transistors is integrated in the lid by injection molding.

This application claims priority from German Patent Application No. 10 2006 026 446.0 filed Jun. 7, 2006, the entire disclosure of which is incorporated herein by reference.

### FIELD OF THE INVENTION

The invention relates to an adjusting device for the adjusting of at least one valve in an internal combustion engine with a housing in which a gearing unit and a drive motor are arranged and that can be closed by a lid, whereby the adjusting device has a stamped grid for the electrical connection of the drive motor and other electrical and electronic components.

### BACKGROUND OF THE INVENTION

Such adjusting devices are used in internal combustion engines for example for adjusting swirl- or tumble valves arranged in an induction pipe. The use for flap valves of induction pipes to adjust the effective ram pipe length is also known. Moreover an integration of such adjusting devices with throttle valve necks is known from various applications.

Thus in DE 101 37 454 A1 a throttle valve neck with an adjusting device is described that has a one-piece housing that has both the air intake pipe to receive the throttle valve and a chamber to receive a drive motor. At the first side of the air intake pipe, a chamber open on one side to receive a gearing unit as well as a non-contact position detection device is arranged on the housing and on the opposite side a plate is arranged for fixing a lid that receives the electronics for the adjusting device, which are arranged on a printed circuit board. The chamber that is open on one side is likewise closed by a lid on which the non-contact position detection device is fixed. Electrical connecting means are integrated in the lids, via which the electronics of the adjusting device are able to contact electrical devices arranged outside the housing, via a plug. For this purpose the lids are manufactured using the injection molding process.

Moreover from DE 195 25 510 A1 an adjusting device for a throttle valve neck is known that has only one single chamber for receiving the drive motor as well as the gearing unit and the electronics. A stamped metal sheet part for the electrical contact is partly cast in the lid that closes the chamber. The stamped metal sheet part is embodied thereby such that it has curved contacts facing the chamber, which contacts, when the lid is fixed on the housing by being placed on it perpendicularly, are brought into frictional, resilient contact with the motor plug contacts or the arms of a potentiometer.

Moreover it is known to produce an electrical contact between the electrical and electronic components and a stamped grid by means of welded joints, which represents a processing step to be carried out additionally.

The disadvantage of the described embodiments is that the lid must first be positioned precisely with respect to the axis of the valve and thus to the housing, in order to produce the electrical contact with the motor. If the lid is twisted even slightly with respect to the housing, no reliable contact is formed. Moreover with such an embodiment it is only possible at great expense to undertake any required changes with respect to the position of the plug in an area outside the lid, due to the space available.

It is therefore the object of the invention to make available an adjusting device for the adjusting of valves in which a reliable electrical contact is possible without welded points and at the same time a guiding of the lid with respect to the housing is ensured for simpler assembly. It is also intended to enable such a design for an adjusting device to be implemented whose plug is arranged in the area of the housing.

### SUMMARY OF THE INVENTION

This object is achieved in that the stamped grid has sections of conductors that are plastic-sheathed in the lid and has non-sheathed sections of the conductors that serve as a hinge for the defined opening and closing of the lid relative to the housing. Through such an adjusting device the assembly is distinctly facilitated through the fixing of the position of the lid with respect to the housing before the lid is closed, whereby at the same time a reliable electrical contact with a long service life is ensured.

In a particularly advantageous embodiment of the invention the sections of the conductors arranged in the housing are likewise plastic-sheathed. Thus it is possible to dispense completely with welding processes or positive and frictional electrical connections that are formed in known embodiments during placement of the lid or must be produced in separate processes, since the entire electronic and electrical system is produced as one component and is potted in plastic in one or two process steps.

Preferably an electronic control system and a non-contact angle sensor are integrated in the lid, so that it is possible to omit an external control or regulating system. The non-contact angle sensor is preferably a magnetoresistive sensor that corresponds with a magnet arranged on a gearing output shaft of the adjusting device and serves to report the position. Depending on the application, this can be a switch for detecting final positions or a sensor that is active over the entire adjusting range.

In a further form of embodiment, the electronic control system is arranged on a printed circuit board that is arranged at least partially sheathed by plastic in the lid, so that the printed circuit board is also fixed during the injection molding process, so that a further assembly step is omitted.

Moreover a plug is preferably embodied on the housing, via which the adjusting device is connected to a motor control device of the internal combustion engine. Through the arrangement of the plug on the housing, distinctly higher degrees of freedom can be achieved with respect to the design of the adjusting device, compared with an adjusting device in which the plug must be embodied on the lid part.

In a particularly preferred form of embodiment the stamped grid is arranged in the lid and only the conductors to the plug and to the contact of the drive motor are fixed in the housing. This facilitates the production of the electronics by a simple forming of the stamped grid and by the injection process for the production of the housing and the lid.

In a further embodiment, the non-sheathed sections of the conductors have defined fold lines, so that the non-sheathed sections of the conductors assume a defined position at the closing of the lid. By these means an additional fixing of the position of the lid with respect to the housing is achieved during the closing procedure, whereby at the same time the exposed conductors are prevented from leading to malfunctions of the adjusting device due to an incorrect position after the assembly.

Preferably the lid is fixed to the housing by means of screws after the closing, as a result of which a simple opening of the adjusting device becomes possible after the assembly.

The invention may take the form of an adjusting device for adjusting at least one valve in an internal combustion engine, comprising a housing, a gearing unit and a drive motor disposed in the housing, a lid disposed to close the housing, and a stamped grid comprising conductors disposed to electrically connect the drive motor and one or more other electrical and electronic components, wherein the stamped grid comprises sections of the conductors that are plastic-sheathed in the lid and further comprises non-sheathed sections of the conductors that serve as a hinge for opening and closing of the lid relative to the housing

Thus such an adjusting device ensures a reliable contact of all the electrical and electronic components of an adjusting device, whereby at the same time the assembly and production expense is minimized. Welding or plugging processes during the assembly are eliminated. Moreover there is a distinct reduction in construction space, since the printed circuit board as well as the stamped grid and the angle sensor are integrated in the lid.

In a further embodiment, there is provided an adjusting device for adjusting at least one valve in an internal combustion engine, comprising a housing. A gearing unit is disposed in the housing a drive motor is also disposed in the housing. A lid is disposed to close the housing. A stamped grid comprising conductors is disposed to electrically connect the drive motor and one or more other electrical and electronic components. The stamped grid comprises plastic-sheathed conductor section in the lid and further comprises non-sheathed conductor sections that serve as a hinge for opening and closing of the lid relative to the housing.

Further objects, features and advantages of the invention will become apparent from the Detailed Description of the Preferred Embodiment which follows, when considered together with the Drawing.

### BRIEF DESCRIPTION OF THE DRAWING

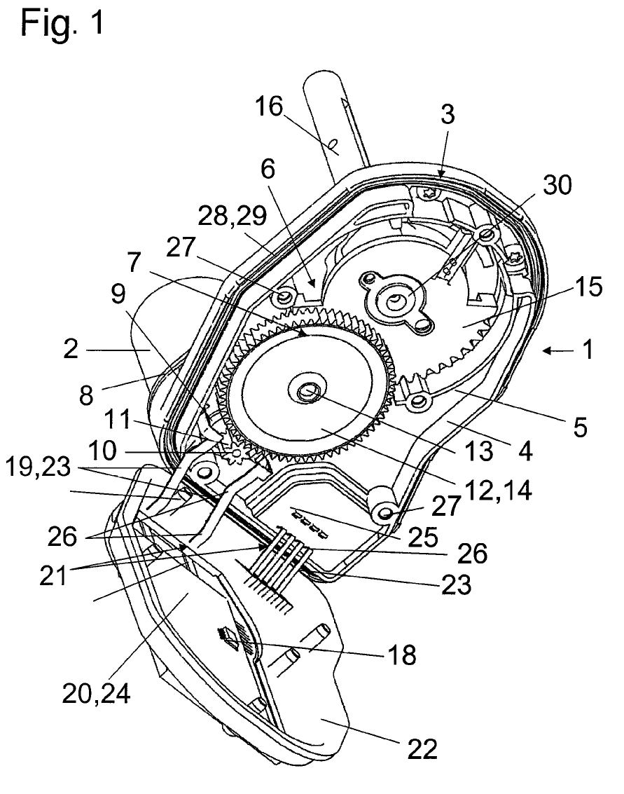

The sole FIGURE 1 shows a perspective illustration of an adjusting device according to the invention for a throttle valve neck with an open lid.

### DETAILED DESCRIPTION OF THE PREFERRED EMBODIMENT

The adjusting device shown in the figure is composed of a two-part housing 1, of which a first housing part 2 is embodied essentially in the form of a pot and serves to accommodate a drive motor, not shown, as well as a second housing part 3 that is embodied essentially in the form of a plate and has side walls 4 extending perpendicularly from the edges of the plate 5, which side walls with the plate 5 of the housing part 3 border a chamber 6 open on one side, in which a gearing unit 7 is arranged. From the side of the plate 5 opposite the side walls 4, the first housing part 2 with the drive motor is placed in a corresponding recess 8 on the plate 5 and is fixed there. A drive shaft 10 of the drive motor, on which a first gear wheel 11 is fixed, projects through an opening 9 in the plate 5 thereby. This gear wheel 11 meshes with a second gear wheel 12 that is pivoted on a pin 13 that is produced in one piece with the second housing part 3. This gear wheel 12 is part of a double gear wheel 14 whose second gear wheel, which cannot be seen in the view, again meshes with a gear wheel segment 15 that is arranged on a gearing output shaft 16.

A torsion spring covered by the gear wheel segment 15 in the figure is connected to the gearing output shaft 16, which torsion spring in case of failure of the electronics or the drive motor turns the gearing output shaft 16 and thus a valve, not shown, arranged on the shaft 16, into a fail-safe position. The valve can be fixed on the gearing output shaft 16 for example via screws. A magnet 30, which with a non-contact angle sensor 18 serves to detect the angle position and corresponding actuation of the drive motor, is arranged on the end of the gearing output shaft 16 arranged in the chamber 6 opposite the valve or on the gear wheel segment 15.

For the power supply and corresponding actuation of the drive motor, the drive motor has two contact elements, not shown, that likewise project through the plate 5, and that are connected to an electronic control system 20 via conductors 19. The conductors 19 are part of a stamped grid 21, via which electrical connections are produced between all the electrical and electronic components.

The conductors 19 of the stamped grid 21 are for the most part arranged in a lid 22 and are sheathed by the plastic of the lid 22. The chamber 6 of the housing 1 is sealed by the lid 22.

The conductors 19 have non-sheathed sections 23 as well as sheathed sections, which are not seen in the illustration. The electronic control system 20, like the non-contact angle sensor 18, is arranged on a printed circuit board 24, which is likewise sheathed at least partly by the plastic of the lid 22. The power transistors of the adjusting device can for example also be arranged on the printed circuit board 24.

The electronic control system 20 and thus the printed circuit board 24 also has a connection to a plug 25 via the conductors 19 or the stamped grid 21. This plug 25 is embodied either in one piece with the second housing part 3 or is inserted with the conductors arranged in it, through an opening embodied in the plate 5 and is connected to the plate 5. Thus during production it is conceivable both to connect sections 23 of the stamped grid 21 that are not sheathed by the plastic of the lid 22 via clamp connections to the plug 25 or the contact elements of the drive motor, and also to sheathe parts of the sections 23 that have not yet been sheathed, with the plastic of the plate 5 or of the second housing part 3 or of the plug 25 during the production of the housing part 3. The plug 25 can also be produced with the lid 22 in this manner for example in an injection molding process. The same is also true for the contact of the motor, whereby here the contact between the motor contacts and the sections of the conductors 19 sheathed by the plastic of the second housing part 3 must be ensured. Either the stamped grid 21 can first be sheathed by the plastic of the lid 22 or of the housing 1 thereby, or the lid and the housing part 3 are injection-molded in one process step.

The plug 25 can be connected via a mating part, not shown, to a motor control device, likewise not shown. The non-sheathed sections 23 of the conductors 19 or of the stamped grid 21 furthermore have fold lines that serve as bending points of the non-sheathed sections 23 of the conductors 19 during the assembly of the lid 22 with the second housing part 3. It is clear from the drawing that these non-sheathed sections 23 serve as a hinge during the closing or opening of the lid 22 and thus guide the lid relative to the second housing part 3.

Moreover several “chimneys” 27 are embodied on the second housing part 3, which chimneys have a female thread, so that after folding, the lid 22 can be fixed detachably to the second housing part 3 via screws, not shown. In order to ensure that the then closed chamber 6 is sealed, a groove 28 facing in the direction of the lid 22 is embodied on the outer edge of the plate 5 or of the side walls 4, in which groove a gasket 29 is embedded that is for example connected permanently to the second housing part 3 during the assembly injection-molding.

The assembly of an adjusting device of this type is thus clearly facilitated by the hinge action of the non-sheathed sections 23 of the conductors 19, since at every angle position of the lid 22 to the housing 1, the lid 22 is always arranged in a defined position to the housing 1.

The electrical contact is secure and has a long service life, in particular due to the sheathing of the stamped grid 21 or the conductors 19 in the lid and optionally also on the housing part 3 or on the plug 25. Moreover the lid 22, printed circuit board 24, stamped grid 21, and angle sensor 18 components are integrated in one component. Welding processes to produce the contact between the electronic control system 20 and the plug 25 or the motor can thus be completely eliminated, as a result of which the contact is improved and one assembly step can also be omitted.

It should be clear that in this context it is advantageous to arrange the non-sheathed sections 23 of the conductors 19 as close as possible to the rotation axis of the lid 22, since in this manner the arrangement of the non-sheathed sections 23 in the assembled state, which can be defined via the fold lines 26, is distinctly facilitated due to the possibility of shortening the conductors 19. In this way opening angles of up to 180° can optionally be implemented.

Of course, the scope of the application is not limited to the described form of embodiment, in particular not to the use as an adjusting device of a throttle valve. Likewise, it is also conceivable to arrange a potentiometer on the lid 22 instead of the non-contact angle sensor 18, which potentiometer can be connected in the same way to the electronic control system 20 or the plug 25 via the sheathed stamped grid 21. Likewise the design of the gearing unit as well as its use can be varied in wide areas, without leaving the scope of the claims.

While the present invention has been described with reference to certain preferred embodiments, one of ordinary skill in the art will recognize that additions, deletions, substitutions, modifications and improvements can be made while remaining within the spirit and scope of the present invention as defined by the appended claims.

1. An adjusting device for adjusting at least one valve in an internal combustion engine, comprising:
a housing;
a gearing unit disposed in the housing;
a drive motor disposed in the housing;
a lid disposed to close the housing; and
a stamped grid comprising conductors disposed to electrically connect the drive motor and one or more other electrical and electronic components;
wherein the stamped grid comprises plastic-sheathed conductor sections in the lid and further comprises non-sheathed conductor sections that serve as a hinge for opening and closing of the lid relative to the housing.

2. Adjusting device for the adjusting of at least one valve in an internal combustion engine according to claim 1, further comprising plastic-sheathed sections of the conductors disposed in the housing.

3. Adjusting device for the adjusting of at least one valve in an internal combustion engine according to claim 1, further comprising an electronic control system and a non-contact angle sensor integrated in the lid.

4. Adjusting device for the adjusting of at least one valve in an internal combustion engine according to claim 3, wherein the electronic control system is disposed on a printed circuit board that is disposed at least partly sheathed by the plastic in the lid.

5. Adjusting device for the adjusting of at least one valve in an internal combustion engine according to claim 1, wherein the adjusting device is connectable to a motor control device of the internal combustion engine via a plug is embodied on the housing.

6. Adjusting device for the adjusting of at least one valve in an internal combustion engine according to claim 1, wherein the stamped grid is disposed in the lid and, among parts connected directly to the stamped grid, only the conductors to the plug and to the contact of the drive motor are fixed in the housing.

7. Adjusting device for the adjusting of at least one valve in an internal combustion engine according to claim 1, wherein the non-sheathed sections of the conductors have defined fold lines, so that the non-sheathed sections of the conductors are disposed to assume a defined position upon the closing of the lid.

8. Adjusting device for the adjusting of at least one valve in an internal combustion engine according to claim 1, wherein the lid is fixable to the housing in a closed position by means of screws.

9. Adjusting device for the adjusting of at least one valve in an internal combustion engine according to claim 2, further comprising an electronic control system and a non-contact angle sensor integrated in the lid.

10. Adjusting device for the adjusting of at least one valve in an internal combustion engine according to claim 2, wherein the adjusting device is connectable to a motor control device of the internal combustion engine via a plug is embodied on the housing.

11. Adjusting device for the adjusting of at least one valve in an internal combustion engine according to claim 3, wherein the adjusting device is connectable to a motor control device of the internal combustion engine via a plug is embodied on the housing.

12. Adjusting device for the adjusting of at least one valve in an internal combustion engine according to claim 4, wherein the adjusting device is connectable to a motor control device of the internal combustion engine via a plug is embodied on the housing

13. Adjusting device for the adjusting of at least one valve in an internal combustion engine according to claim 2, wherein the stamped grid is disposed in the lid and, among parts connected directly to the stamped grid, only the conductors to the plug and to the contact of the drive motor are fixed in the housing.

14. Adjusting device for the adjusting of at least one valve in an internal combustion engine according to claim 3, wherein the stamped grid is disposed in the lid and, among parts connected directly to the stamped grid, only the conductors to the plug and to the contact of the drive motor are fixed in the housing.

15. Adjusting device for the adjusting of at least one valve in an internal combustion engine according to claim 4, wherein the stamped grid is disposed in the lid and, among parts connected directly to the stamped grid, only the conductors to the plug and to the contact of the drive motor are fixed in the housing.

16. Adjusting device for the adjusting of at least one valve in an internal combustion engine according to claim 5, wherein the stamped grid is disposed in the lid and, among parts connected directly to the stamped grid, only the conductors to the plug and to the contact of the drive motor are fixed in the housing.

17. Adjusting device for the adjusting of at least one valve in an internal combustion engine according to claim 2, wherein the non-sheathed sections of the conductors have defined fold lines, so that the non-sheathed sections of the conductors are disposed to assume a defined position upon the closing of the lid.

18. Adjusting device for the adjusting of at least one valve in an internal combustion engine according to claim 3, wherein the non-sheathed sections of the conductors have defined fold lines, so that the non-sheathed sections of the conductors are disposed to assume a defined position upon the closing of the lid.

19. Adjusting device for the adjusting of at least one valve in an internal combustion engine according to claim 4, wherein the non-sheathed sections of the conductors have defined fold lines, so that the non-sheathed sections of the conductors are disposed to assume a defined position upon the closing of the lid.

20. Adjusting device for the adjusting of at least one valve in an internal combustion engine according to claim 5, wherein the non-sheathed sections of the conductors have defined fold lines, so that the non-sheathed sections of the conductors are disposed to assume a defined position upon the closing of the lid.
